(19) United States
(12) Patent Application Publication
(10) Pub. No.: US 2026/0027837 A1
(43) Pub. Date: Jan. 29, 2026

(54) INKJET PRINTING APPARATUS AND INFORMATION PROCESSING METHOD

(71) Applicant: CANON KABUSHIKI KAISHA, Tokyo (JP)

(72) Inventors: TAKAAKI SHIMA, Tokyo (JP); KAZUKI NARUMI, Tokyo (JP); NOBORU KUNIMINE, Tokyo (JP)

(21) Appl. No.: 19/282,521

(22) Filed: Jul. 28, 2025

(30) Foreign Application Priority Data
Jul. 29, 2024 (JP) 2024-122548

(51) Int. Cl. B41J 2/21; B41J 3/407; B41J 11/00; B41M 3/00; B41M 5/00; B41M 7/00; C09D 11/30; C09D 11/54

(52) U.S. Cl. CPC B41J 2/2107; B41J 3/407; B41J 11/0024; B41M 3/001; B41M 5/0047; B41M 5/0064; B41M 7/009; C09D 11/30; C09D 11/54

(57) ABSTRACT

An inkjet printing apparatus comprises: a printing unit configured to print an image on a print medium, the printing unit including a first discharge portion configured to apply ink, and a second discharge portion configured to apply a reactive liquid; and a determination unit configured to determine an application amount of the reactive liquid based on an application amount of the ink for each partial area of the print medium. The second discharge portion is configured to apply at least one of a first reactive liquid and a second reactive liquid. The determination unit determines an application amount of the first reactive liquid and an application amount of the second reactive liquid based on the application amount of the ink.

### BACKGROUND

### Field of the Technology

The present disclosure relates to a printing apparatus that discharges ink to form an image.

### Description of the Related Art

In inkjet printing apparatuses using a pigment ink, a demand is increasing for inkjet printing on a polyvinyl chloride sheet (vinyl chloride sheet) used as enamel paper for commercial/publishing printing. There is a printing method of printing on such print media by discharging a color material-containing ink and a reactive liquid to a print medium to make them react with each other on the print medium and coagulate the color material.

A printing method using a reactive liquid generally changes the application amount of the reactive liquid in accordance with the print tone of ink. For example, in a print area of low print tone, the application amount of the reactive liquid is increased to increase the coverage of a print medium with the reactive liquid so that the bonding of color materials of reactants becomes uniform. However, in a case where an organic acid or a polyvalent metal salt is used as the reactive liquid, if the number of components of the reactive liquid increases, precipitation of the reactive component or polyvalent metal salt readily occurs on an image. Japanese Patent Laid-Open No. 2019-155706 (patent literature 1) has proposed a technique of suppressing precipitation by using a low-concentration reactive liquid in a print area of low print tone.

However, in a print area of high print tone, a precipitate may be visually recognized as the white turbidity of an image. It is difficult to sufficiently suppress the white turbidity in a print area of high print tone by only a method as described in patent literature 1. Some reactants tend not to have such precipitation, but the image print surface readily becomes uneven and the gloss readily degrades owing to the coagulation of ink.

### SUMMARY

The present disclosure provides a technique capable of high-quality image printing.

According to one aspect of the present disclosure, an inkjet printing apparatus comprises: a printing unit configured to print an image on a print medium, the printing unit including a first discharge portion configured to apply, to the print medium, ink containing resin particles and a color material, and a second discharge portion configured to apply, to the print medium, a reactive liquid that reacts with the resin particles and the color material in the ink to coagulate the resin particles and the color material or cause gelation; and a determination unit configured to determine an application amount of the reactive liquid based on an application amount of the ink for each partial area of the print medium, wherein the second discharge portion is configured to apply, as the reactive liquid, at least one of a first reactive liquid having a first composition and a second reactive liquid having a second composition different from the first composition, and the determination unit determines an application amount of the first reactive liquid and an application amount of the second reactive liquid to make different a first ratio serving as a ratio of the application amount of the second reactive liquid to a total application amount of the first reactive liquid and the second reactive liquid in a case where the application amount of the ink is a first application amount, and a second ratio serving as a ratio of the application amount of the second reactive liquid to the total application amount of the first reactive liquid and the second reactive liquid in a case where the application amount of the ink is a second application amount larger than the first application amount.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are views showing the configuration of an inkjet printing apparatus;

FIG. 2 is a schematic view of a printhead when viewed from the orifice side;

FIG. 3 is a schematic view showing a printing control system;

FIG. 4 is a flowchart showing an image data processing sequence;

FIG. 5 is a view for explaining general print data generation;

FIG. 6 is a view for explaining a general multi-pass printing method;

FIGS. 7A and 7B are graphs showing tables in which the relationship between the ink application amount and the reactive liquid application amount is stored;

FIG. 8 is a flowchart showing an image data processing sequence;

FIG. 9 is a graph showing a table in which the relationship between the ink application amount and the reactive liquid application amount is stored;

FIG. 10 is a flowchart showing an image data processing sequence; and

FIG. 11 is a graph showing a table in which the relationship between the ink application amount and the reactive liquid application amount is stored.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

As the first embodiment of a printing apparatus according to the present disclosure, a printing apparatus using an inkjet printing method will be exemplified below. The printing apparatus may be a single-function printer having only a print function, or a multi-function printer having a plurality of functions such as a print function, a FAX function, and a scanner function.

In the following description, “print” means the formation of images such as characters and graphics on a print medium such as paper. Note that “print” includes the formation of images, figures, patterns, and the like on a print medium, or the processing of the medium, regardless of whether formed images are so visualized as to be visually perceivable by humans.

Also, a “print medium” includes not only paper used in common printing apparatuses, but also materials capable of accepting ink such as cloth, a plastic film, a metal plate, glass, ceramics, a resin, wood, and leather. Examples of a nonabsorbable print medium are glass, plastic, a film, and YUPO fabricated not as print media for water-based inkjet ink. Other examples are print media not surface-treated (that is, no ink absorption layer is formed) for inkjet printing, such as a plastic film, and a plastic-coated base such as paper. Examples of plastic are polyvinyl chloride, polyethylene terephthalate, polycarbonate, polystyrene, polyurethane, polyethylene, and polypropylene. An example of a low-absorbable print medium is actual printing stock used in offset printing or the like, such as art paper or coated paper.

### <Apparatus Configuration>

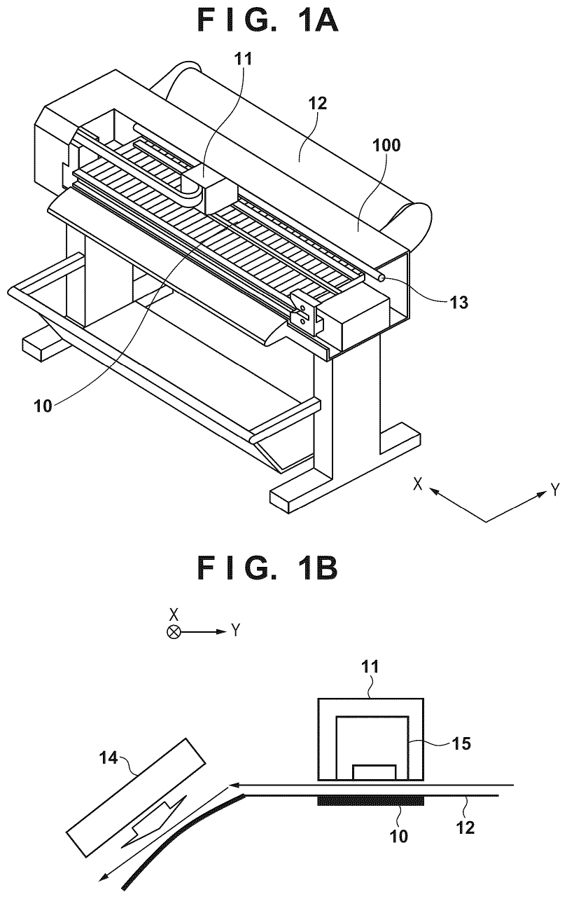

FIGS. 1A and 1B are views showing the configuration of an inkjet printing apparatus 100. FIG. 1A is a partially exploded perspective view for explaining the internal mechanism, and FIG. 1B is a sectional view. As shown in FIG. 1B, a print medium 12 is conveyed in the −Y direction in FIG. 1B along with driving of a sub-scanning motor (not shown). A guide shaft 13 is arranged to extend in the X direction crossing the Y direction serving as the conveyance direction of the print medium 12.

While supported by the guide shaft 13, a carriage 11 on which a printhead 15 arranged to face a platen 10 is mounted reciprocates (reciprocally scans) in the X direction by driving of a main scanning motor (not shown). During moving scanning of the carriage 11, the printhead 15 mounted on the carriage 11 discharges ink to the print medium 12 in accordance with print data, thereby printing on the print medium 12.

The inkjet printing apparatus 100 according to this embodiment adopts a so-called bidirectional printing method of printing an image on a print medium by discharging ink in both a case where the printhead 15 moves along the forward path and a case where it moves along the return path. When scanning accompanied by one printing by the printhead 15 is performed, the print medium 12 is conveyed by a predetermined amount by the sub-scanning motor (not shown). The main scanning speed is variable, and scanning is possible at 10 to 70 inches/sec. The print resolution is also variable, and the discharge operation can be performed at 300 to 2,400 dots/inch (dpi). After the above-mentioned scanning, the print medium 12 is conveyed, and the next printing is performed in an area of the print medium shifted by the conveyance amount.

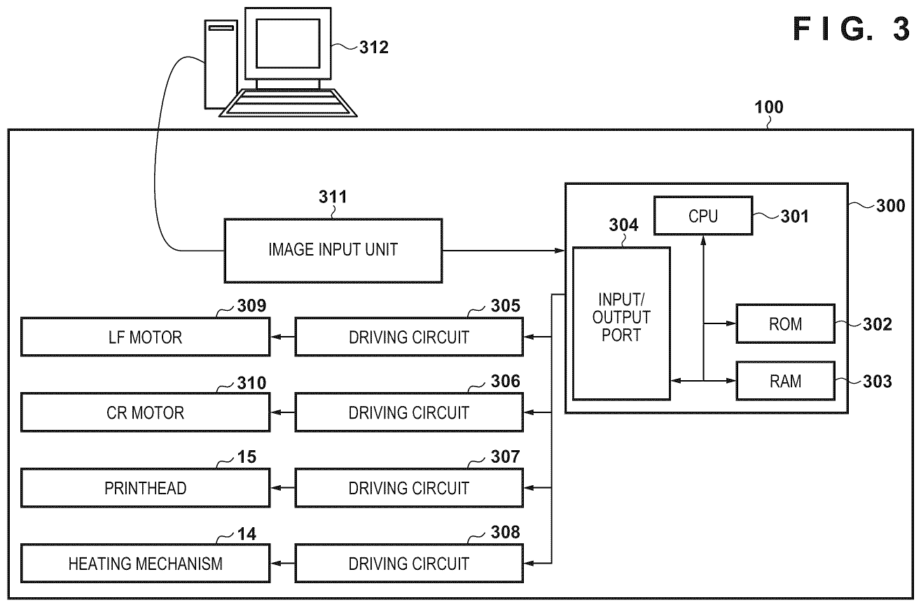

When a print operation command is input from an external apparatus 312 to be described later with reference to FIG. 3, the print medium 12 is fed to a position where the printhead 15 mounted on the carriage 11 can print. Then, main scanning of the printhead 15 while discharging ink in accordance with a print signal, and the conveyance operation of the print medium 12 by a predetermined amount are alternately repeated, thereby printing an image. The image formed on the print medium 12 on the platen 10 is conveyed in the −Y direction, and exposed to hot air by a heating mechanism 14 to heat the print medium to 60° C. to 120° C., thereby heating and fixing the image. The heating mechanism 14 also has a function of heating water-soluble resin particles (to be described later) to form a film in the printing apparatus. The water-soluble resin particles are a resin that forms a film by heating when applied onto a print medium, in order to improve the scratch resistance of an image. In this embodiment, the temperature setting is adjusted to be 80° C. on a print medium.

In this embodiment, the printhead 15 serving as a printing portion is configured to discharge color inks K, C, M, and Y and a white ink W. In addition, the printhead 15 is configured to discharge two types of reactive liquids RCT1 and RCT2. The reactive liquid contains a reactant, and reacts with solid contents such as a color material and resin particles contained in each ink to promote the coagulation. Details of the inks and reactive liquids will be described later.

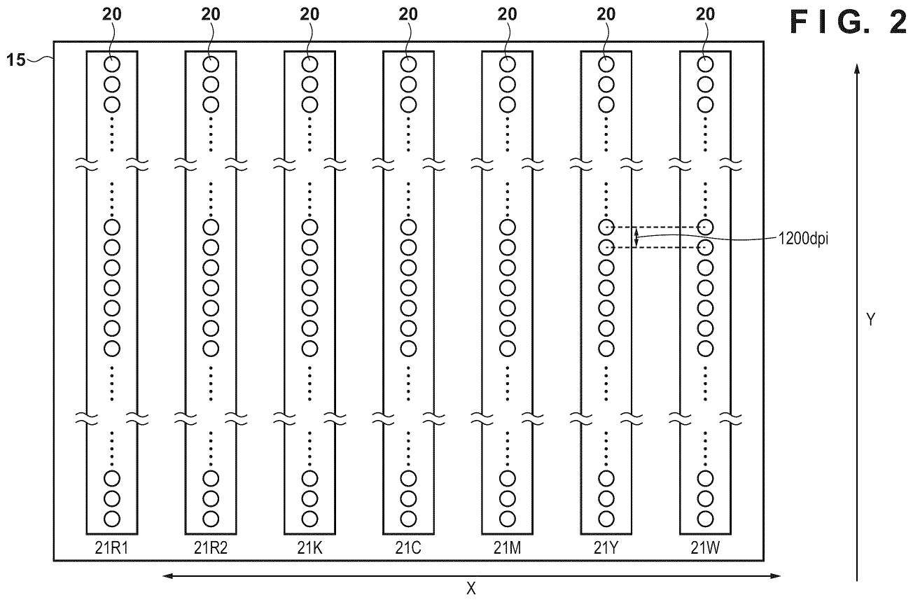

FIG. 2 is a schematic view for explaining in detail the printhead 15 that discharges ink and a reactive liquid, and is a view of the configuration of the printhead 15 when viewed from the orifice surface. In the printhead 15, 1,024 orifices 20 provided with printing elements are arrayed in the Y direction at a density of 1,200 per inch. This array forms a discharge portion (orifice array) for one color. In this embodiment, seven orifice array forming substrates are implemented. The orifice array forming substrates include an orifice array 21R1 for the first reactive liquid RCT1, and an orifice array 21R2 for the second reactive liquid RCT2, which are discharge portions (orifice arrays) for the two types of reactive liquids. The orifice array forming substrates also include a black (K) orifice array 21K, a cyan (C) orifice array 21C, a magenta (M) orifice array 21M, a yellow (Y) orifice array 21Y, and a white (W) orifice array 21W, which are orifice arrays for the respective color inks.

The discharge amounts of the inks and reactive liquids discharged from the respective orifices 20 are about 4.5 pl. However, the discharge amount is not limited to this, and may have different settings between the inks and the reactive liquids or may be changed for each ink. The printhead 15 discharges the inks and the reactive liquids from the orifices 20 by discharge energy generated by the printing elements such as electrothermal transducers (heaters) or piezoelectric elements. When the electrothermal transducers are used, water in ink can be bubbled by heat generated by the electrothermal transducers to discharge the ink using the bubbling energy. The discharge portions need not always be formed on a single printhead and may be separated. The discharge portions are connected to ink tanks (not shown) in which corresponding inks are stored, and receive the inks. Note that the printhead 15 and ink tanks used in this embodiment may be integrated or separable.

FIG. 3 is a schematic view showing a printing control system. An image input unit 311 inputs various image data from the external apparatus 312 such as a personal computer (PC). The image data are, for example, multi-value image data from an image input device such as a scanner or a digital camera, and multi-value image data saved in various recording media such as a hard disk. An image processing unit 300 converts input multi-value image data into binary image data by image processing (to be described later). The binary image data includes image data of the color inks K, C, M, and Y, the white ink W, and the reactive liquids RCT1 and RCT2.

A central processing unit (CPU) 301 controls each unit of the printing apparatus. A read only memory (ROM) 302 stores control programs, error processing programs, and the like that are executed by the CPU 301. A random access memory (RAM) 303 temporarily saves various data (image data, print signals supplied to the printhead, and the like). An input/output port 304 performs control of an LF motor 309, a CR motor 310, and driving circuits 305 to 308 for driving the printhead 15. The input/output port 304 also performs control of data transfer between the image input unit 311, the CPU 301, and the RAM 303.

The LF motor 309 is a motor for conveying the print medium 12 in the −Y direction (sub-scanning direction), and the CR motor 310 is a motor for moving the printhead 15 in the X direction (main scanning direction). The driving circuits 305 and 306 are motor drivers for driving the LF motor 309 and the CR motor 310, respectively. The driving circuit 307 is a head driver for driving the printhead 15. An image can be printed on the print medium 12 by driving the LF motor 309 and the CR motor 310, and also driving the printhead 15 based on binary print data generated by the image input unit 311. The heating mechanism 14 is driven by the driving circuit 308 to heat the print medium 12.

### <Operation of Apparatus>

In this embodiment, an image is printed according to a multi-pass printing method of printing an image in a unit area (partial area) on a print medium by a plurality of scans. In each of the scans, droplets (inks and reactive liquids) are discharged in accordance with print data that defines discharge or non-discharge of droplets to respective pixels.

In this embodiment, print data corresponding to each of scans is generated from image data by using a dither mask and a pass mask. A general processing method of image data in a case where printing (image formation) is performed by eight passes using the dither mask and the pass mask will be described below. Note that image data is 8-bit data capable of representing 256 tone values of 0 to 255 for descriptive convenience. Here, both the dither mask and the pass mask have a size corresponding to an area of 8 pixels×8 pixels corresponding to the unit area.

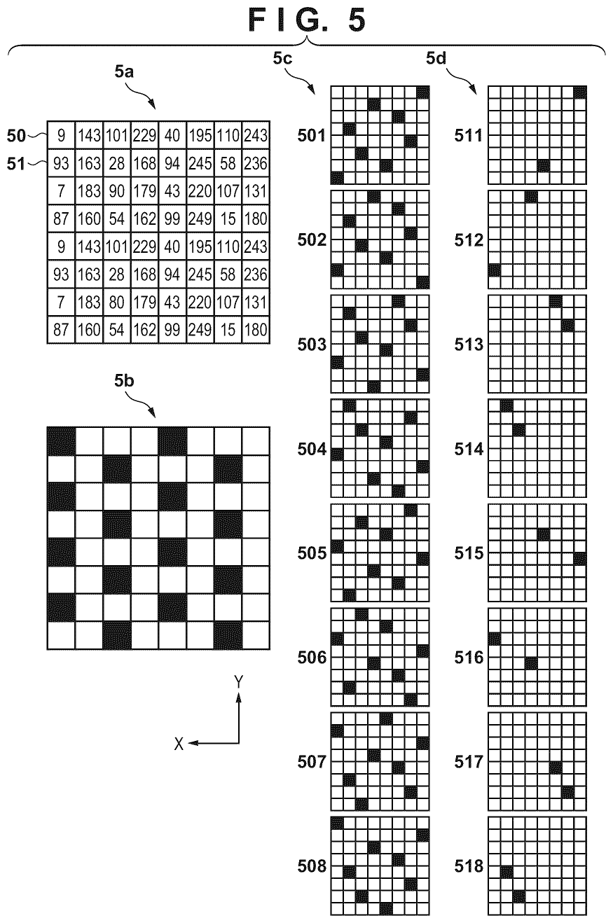

FIG. 5 is a view for explaining general print data generation. That is, FIG. 5 shows a method of processing the above-mentioned image data to generate print data. Note that 5a is a view schematically showing an example of the dither mask. 5b is a schematic view showing binary data generated by applying the dither mask shown in 5a to image data having a tone value (information representing tone) “64”. Further, 5c is a schematic view showing an example of pass masks 501 to 508 of droplets respectively corresponding to the first to eighth scans. In each scan, a maximum of one dot per pixel is printed as a unit pixel at 2,400 dpi in the X direction and 1,200 dpi in the Y direction. 5d is a schematic view showing print data 511 to 518 that are generated by applying the pass masks 501 to 508 in 5c to the binary data shown in 5b, and correspond to the respective first to eighth scans. The pass masks 501 to 508 in 5c are mask patterns with which a total of one dot is printed in each pixel by eight scans. However, mask patterns with which two or more dots are printed in each pixel are also available, and the mask patterns can be set in accordance with a desired droplet print amount for a unit area on a print medium.

As shown in 5a, the dither mask defines different thresholds for respective pixels. When the tone value of multi-value data is larger than a threshold to be compared in each pixel, the multi-value data is converted into binary data (1-bit data) representing “discharge of a droplet” to the pixel. In contrast, when the tone value of multi-value data is equal to or smaller than the threshold to be compared in each pixel, the multi-value data is converted into binary data representing “non-discharge of a droplet” to the pixel. Note that a form in which multi-value data of the same value is input to all pixel areas in a given unit area will be explained below, but multi-value data of different values for respective pixel areas may be input.

For example, when the tone value of multi-value data in a previous pixel is “64”, a threshold in a pixel 50 of the dither mask shown in 5a is “9” (<64), and thus multi-value data corresponding to the pixel 50 is converted into binary data representing “discharge of a droplet”. A threshold in a pixel 51 is “93” (>64), and multi-value data corresponding to the pixel 51 is converted into binary data representing “non-discharge of a droplet”. In this manner, the dither mask shown in 5a is used to generate binary data shown in 5b from multi-value data representing the tone value “64”.

As represented in the pass masks 501 to 508 of 5c, the pass mask is constituted by arranging print-permitted pixels in which discharge of a droplet is permitted, and print-inhibited pixels in which discharge of a droplet is inhibited. Note that filled portions in each of the pass masks 501 to 508 in 5c represent print-permitted pixels, and blank portions represent print-inhibited pixels.

Print data corresponding to each scan is generated by ANDing input binary data and a pass mask corresponding to each scan. That is, when binary data representing discharge of a droplet is input for a print-permitted pixel, it is converted into print data representing discharge of a droplet. To the contrary, even when binary data representing discharge of a droplet is input for a print-inhibited pixel, it is converted into print data representing non-discharge of a droplet.

More specifically, a pass mask represented by the pass mask 501 in 5c corresponding to the first scan is applied to binary data shown in 5b to distribute the binary data and generate print data corresponding to the first scan that is represented by the print data 511 in 5d. Similarly, the binary data shown in 5b is distributed to the respective second to eighth scans to generate print data corresponding to the second to eighth scans that are represented by the print data 512 to 518 in 5d. In each of the first to eighth scans, droplets are discharged in accordance with the thus-generated print data, thereby printing an image.

The above-mentioned multi-pass printing method will be described in detail below. Note that a case where image data having a tone value of 64 is input will be explained here. As described above, when image data having a tone value of 64 is input, print data respectively represented by the print data 511 to 518 in 5d are generated, and droplets are discharged in accordance with the print data.

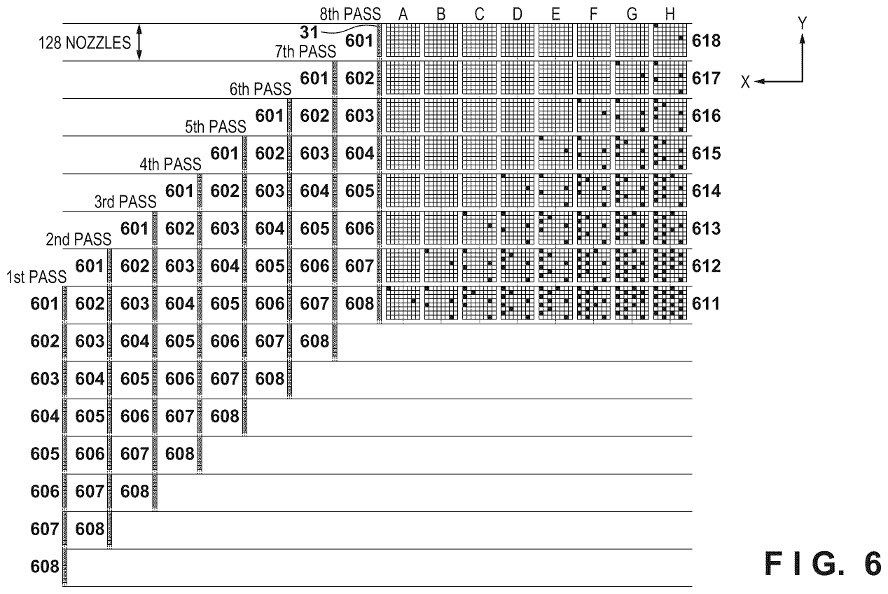

FIG. 6 is a view for explaining a general multi-pass printing method. FIG. 6 shows a state in which printing is performed in a unit area on a print medium by eight print scans by a printhead having 1,024 orifices in one orifice array. FIG. 6 shows an example in which the pass mask of 8 pixels×8 pixels shown in 5c is used for descriptive convenience. Also, FIG. 6 shows an example in which a printhead having one orifice array is used as the printhead 15.

The respective orifices 20 provided in an orifice array 21 for discharging a droplet are divided into eight print groups 601, 602, 603, 604, 605, 606, 607, and 608 in the Y direction.

In the first print scan, droplets are discharged from the print group 601 to an area 611 on the print medium 12 in accordance with the print data 511 in 5d. As a result, droplets are discharged to positions represented in black in A of FIG. 6 on the print medium. Then, the print medium 12 is relatively conveyed by a distance corresponding to 128(=1024/8) orifices in the Y direction with respect to the printhead 15. After that, the second print scan is performed.

In the second print scan, droplets are discharged from the print group 602 to the area 611 on the print medium in accordance with the print data 512 in 5d. In addition, droplets are discharged from the print group 601 to an area 612 in accordance with the print data 511 in 5d. As a result of the second print scan, an image as represented in the area 611 of “B column” is formed on the print medium 12.

Subsequently, scanning of the printhead 15 and relative conveyance of the print medium 12 are alternately repeated. After the eighth print scan is performed, an image as represented in the area 611 of “H column” is formed on the print medium 12, and discharge of droplets is completed for 25% of a printable pixel area.

A general example in a case where 8-pass printing is performed by a printhead having 1,024 orifices used in this embodiment has been explained.

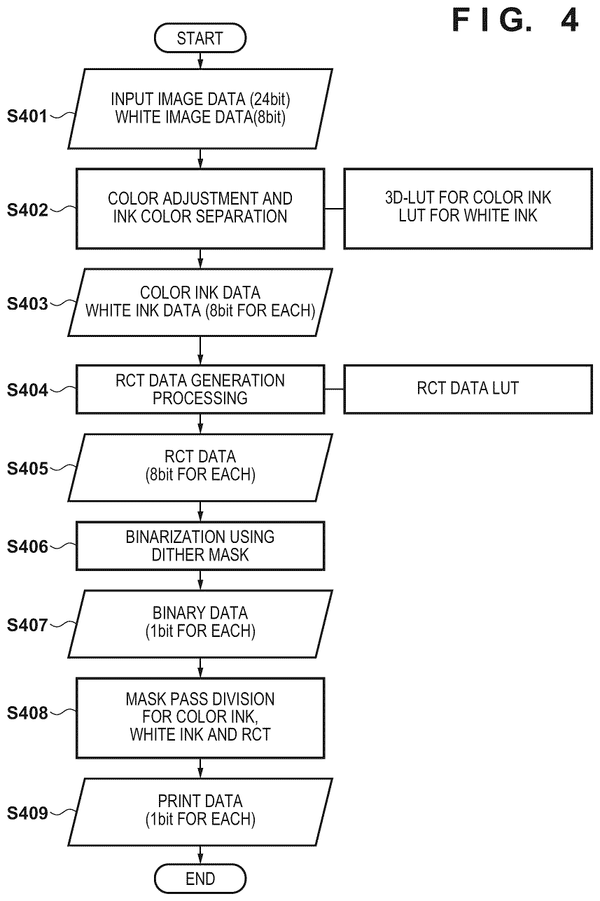

FIG. 4 is a flowchart showing an image data processing sequence. The program of this sequence is stored in, for example, the ROM 302 and executed by the CPU 301. This sequence starts when the image processing unit 300 accepts input of RGB data from the external apparatus 312 via the image input unit 311. In FIG. 4, rectangular blocks represent image processing steps, and parallelogrammic blocks represent data input steps.

In step S401, the image processing unit 300 accepts input of image data (8-bit tone for each of R, G, and B). Similarly, the image processing unit 300 accepts input of white image data (8-bit tone). Note that an area occupied by a white image with respect to a print medium can be determined in correspondence with a stacked color image, arbitrarily by the apparatus user, or in correspondence with print conditions.

In step S402, the image processing unit 300 converts the input image data into multi-value color ink data corresponding to the respective color inks C, M, Y, and K used for image printing by color adjustment processing and ink color separation processing. More specifically, while looking up a color conversion lookup table (LUT), the image processing unit 300 converts the input image data for each predetermined area into color ink data corresponding to a plurality of ink colors available in the printing apparatus. The image processing unit 300 executes similar processing even for white image data, thus converting the input image data into white ink data.

The number of dimensions of the LUT means the number of components of input image data. In this embodiment, input image data are three R, G, and B components, so a three-dimensional (3D)-LUT is used.

In step S403, the image processing unit 300 sets the generated color ink data and white ink data as inputs in steps S404 and S406. The color ink data generated in step S402 represent, for example, 8-bit tones for the respective colors, and have a resolution of 600 dpi at this stage. To cope with a print mode of 2,400 dpi×1,200 dpi, the printing apparatus performs tone expression for each print area of 4×2 dots (4 dots in the X direction and 2 dots in the Y direction). In other words, the printing apparatus performs tone expression for each unit area (one pixel) at a resolution of 600 dpi×600 dpi. Note that an index representing the degree of filling of a unit area with a print dot is called a print duty in the unit area.

In step S404, the image processing unit 300 generates reactive liquid (RCT) data based on the color ink data and the white ink data. More specifically, the image processing unit 300 sets a reactive liquid application amount in each pixel based on a table (RCT data LUT) in which the relationship between the ink application amount, the white ink application amount, and the reactive liquid application amount is stored for each type of print medium. Then, the image processing unit 300 generates 8-bit image data (RCT data) corresponding to the set application amount. Details of the reactive liquid application amount setting will be described later. Here, two RCT data for two types of reactive liquids (to be described later) are generated for at least the color ink data. In step S405, the image processing unit 300 sets the generated RCT data (two RCT data for the color inks and one RCT data for the white ink) as inputs in step S406.

In step S406, the image processing unit 300 binarizes the color ink data, the white ink data, and the RCT data using a dither mask. Binarization using the dither mask is the same as the processing explained with reference to FIG. 5. During the processing, a dither mask and a pass mask stored in the ROM 302 are expanded in the RAM 303, and data generated in each step is also stored in the RAM 303. In step S407, the image processing unit 300 sets the generated binary data as inputs in step S408.

In step S408, the image processing unit 300 performs pass division on the color ink data, the white ink data, and the RCT data. In the first embodiment, the data are processed using the pass masks shown in FIG. 6. In step S409, the image processing unit 300 generates, based on the data divided (having undergone pass division) for each scan in step S408, print data for driving printing elements arranged in the printhead, and executes printing.

### <Compositions of Inks and Reactive Liquids>

The compositions of inks (water-soluble resin particle inks) used in this embodiment will be explained. In the following description, “part” or “%” is the mass standard, unless otherwise specified. The color inks K, C, M, and Y, the white ink W, and the reactive liquid RCT used in this embodiment contain water-soluble organic solvents. The boiling point of the water-soluble organic solvent is preferably 150° C. or more and 300° C. or less in terms of the wettability and moisture retention of the face surface of the printhead. Preferable examples of the water-soluble organic solvent are ketone compounds such as acetone and cyclohexanone in terms of the function of a film formation assistant to resin particles and the swelling and solubility of a resin layer-formed print medium. Other preferable examples of the water-soluble organic solvent are an ethylene glycol derivative such as tetraethylene glycol dimethyl ether, and a heterocyclic compound having a lactam structure typified by N-methyl-pyrrolidone or 2-pyrrolidone. From the viewpoint of the discharge performance, the content of the water-soluble organic solvent is preferably 3 wt % or more and 30 wt % or less.

Examples of the water-soluble organic solvent are alkyl alcohols having 1 to 4 carbon atoms such as methyl alcohol, ethyl alcohol, n-propyl alcohol, isopropyl alcohol, n-butyl alcohol, sec-butyl alcohol, and tert-butyl alcohol, amides such as dimethylformamide and dimethylacetamide, ketones or keto alcohols such as acetone and diacetone alcohol, ethers such as tetrahydrofuran and dioxane, polyalkylene glycols such as polyethylene glycol and polypropylene glycol, ethylene glycol, or alkylene glycols with alkylene groups containing 2 to 6 carbon atoms such as propylene glycol, butylene glycol, triethylene glycol, 1,2,6-hexanetriol, thioglycol, hexylene glycol, and diethylene glycol, lower alkyl ether acetates such as polyethylene glycol monomethyl ether acetate, glycerin, lower alkyl ethers of polyalcohol such as ethylene glycol monomethyl (or ethyl) ether, diethylene glycol methyl (or ethyl) ether, and triethylene glycol monomethyl (or ethyl) ether, polyalcohols such as trimethylolpropane and trimethylolethane, N-methyl-2-pyrrolidone, 2-pyrrolidone, and 1,3-dimethyl-2-imidazolidinone. The above-mentioned water-soluble organic solvents may be used alone or as mixtures. As water, deionized water is desirable. Note that the content of the water-soluble organic solvent of the reactive liquid RCT is not specifically limited. To apply desired physical properties to the color inks K, C, M, and Y and the white ink W if necessary, an anti-foaming agent, a preservative, a defoamer, and the like can be properly added together with the above-mentioned components.

The color inks K, C, M, and Y, the white ink W, and the reactive liquid RCT used in this form contain a surfactant. The surfactant is used to improve the wet spreadability of ink with respect to a print medium. As the additive amount of the surfactant is larger, the property to decrease the surface tension of ink becomes stronger, improving the wet spreadability of ink with respect to a print medium. In this form, a small amount of acetylene glycol EO adduct or the like was added as the surfactant to adjust the static surface tension of each ink to be 30×10⁻³ N/m or less and the difference between the static surface tensions of the color material inks to be 2×10⁻³ N/m or less. More specifically, the static surface tensions of the inks were adjusted to be about 22 to 24×10⁻³ N/m. The static surface tension of ink was measured using a fully automatic surface tension meter CBVP-Z (available from Kyowa Interface Science). Note that the measurement device is not limited to the exemplified one as long as it can measure the static surface tension of ink.

The pH of each ink in this form stabilizes on the alkali side and the value is 8.5 to 9.5. The pH of each ink is preferably 7.0 or more and 10.0 or less in terms of preventing elution and degradation of a member that contacts each ink in the printing apparatus or the printhead, a decrease in solubility of the dispersion resin within the color material ink, and the like. The pH was measured using a pH METER F-52 available from Horiba. Note that the measurement device is not limited to the exemplified one as long as it can measure the pH of ink.

The color inks and the white ink used in this form contain a water-soluble resin emulsion. In this form, the “water-soluble resin emulsion” means polymer particles present in a state in which they are dispersed in water. Examples of the water-soluble resin emulsion are acrylic resin particles synthesized by emulsion polymerization of monomers such as (meth)acrylic acid alkyl ester and (meth)acrylic acid alkyl amide, styrene-acrylic resin particles synthesized by emulsion polymerization of styrene monomers such as (meth)acrylic acid alkyl esters and (meth)acrylic acid alkyl amides, polyethylene resin particles, polypropylene resin particles, polyurethane resin particles, and styrene-butadiene resin particles. Examples of the water-soluble resin emulsion may be core-shell resin particles in which the polymer composition differs between the core and shell constituting the resin particle, and resin particles obtained by emulsion polymerization around pre-synthesized acrylic particles used as seed particles to control the particle size. Further, examples of the water-soluble resin emulsion may be hybrid resin particles obtained by chemically bonding different resin particles such as acrylic resin particles and urethane resin particles.

The color inks and white ink used in this form contain a lubricant. In this form, the “lubricant” means wax particles or silicone oil. Examples of the wax particles are synthetic wax particles such as Fischer-Tropsch wax (EMUSTAR-6315) available from Nippon Seiro, and polyolefin wax (Hi-Tech E-9500) available from Toho Chemical Industry. Further, examples of the wax particles are natural wax particles such as carnauba wax (Cerozol 524) available from Chukyo Yushi, and paraffin wax (AQUACER 497) available from BYK Japan. The lubricant may be silicone oil such as polyether-modified silicone (BYK 333) available from BYK Japan.

In this form, printing is performed using a reactive liquid for insolubilizing part or all of the solid components of the color inks and white ink, in order to solve problems of an image such as bleeding and beading.

The reactive liquid aims to insolubilize a dissolved dye, or a dispersed pigment and resins. The reactant of the reactive liquid for this purpose is, for example, polyvalent metal ions (for example, magnesium sulfate, magnesium nitrate, magnesium chloride, emulsified calcium, aluminum sulfate, and iron chloride). One group of coagulation using such cations can be a series using a low-molecular-weight cationic polymer to neutralize the charges of a water-soluble resin emulsion and insolubilize an anionic soluble substance.

Another reaction series is, for example, an insolubilization system of a reactive liquid that utilizes the difference in pH. As described above, most color inks and white inks used in inkjet printing generally stabilize on the alkali side because of their properties such as the properties of color materials. For example, the pH is often set at 7.0 or more and 10.0 or less from a general industrial viewpoint, or mainly set around 8.5 to 9.5 in consideration of the influence of an external environment and the like. To coagulate and solidify color inks and white inks of such a series, an acid solution can be mixed to change the pH, break the stable state, and coagulate dispersed components. For such an action, an acid solution can be used as the reactive liquid.

### <Preparation Method of Inks and Reactive Liquids>

### Resin Particle Dispersion Liquid

A resin particle dispersion liquid used in the first embodiment was prepared by, first, dropping and adding the following three additive liquids little by little while stirring them in a state in which they were heated to 70° C. in a nitrogen atmosphere, and then polymerizing them for 5 h. The additive liquids were a hydrophobic monomer consisting of 28.5 parts of methyl methacrylate, a solution mixture containing a hydrophilic monomer containing of 4.3 parts of sodium p-styrene sulfonate and 30 parts of water, and a solution mixture containing a polymerization initiator consisting of 0.05 parts of potassium persulfate and 30 parts of water. In this manner, a 20-mass % resin particle dispersion liquid was obtained.

### Black Ink

### (K1) Preparation of Dispersion Liquid

An anionic polymer P-1 [styrene/butyl acrylate/acrylic acid copolymer (polymerization ratio (weight ratio)=30/40/30), acid value of 202, weight-average molecular weight of 6500] was prepared. The polymer was neutralized with an aqueous potassium hydroxide solution and diluted with ion-exchanged water, thus preparing a homogeneous 10-mass % polymer solution.

Then, 600 g of the polymer solution, 100 g of carbon black, and 300 g of ion-exchanged water were mixed and mechanically stirred for a predetermined time. The mixture was then subjected to centrifugal separation processing to remove undispersed substances containing coarse particles, thus obtaining a black dispersion liquid. The obtained black dispersion liquid had a pigment concentration of 10 mass %.

### (K2) Preparation of Ink

An ink was prepared by using the black dispersion liquid and adding the following components to it to have a predetermined concentration. After these components were fully mixed and stirred, they were pressure-filtrated through a microfilter of a 2.5-μm pore size (available from Fujifilm), thus preparing a pigment ink having a pigment concentration of 2 mass %.

| | | |
|---|---|---|
| the black dispersion liquid | 20 | parts |
| the resin particle dispersion liquid | 40 | parts |
| wax particles | 3 | parts |
| Zonyl FSO-100 (fluorine surfactant | 0.05 | parts |
| available from DuPont) | | |
| 2-methyl-1,3-propanediol | 15 | parts |
| 2-pyrrolidone | 5 | parts |
| acetylene glycol EO adduct (available | 0.5 | parts |
| from Kawaken Fine Chemicals) | | |

| | |
|---|---|
| ion-exchanged water | balance |

### Cyan Ink

### (C1) Preparation of Dispersion Liquid

An AB block polymer having an acid value of 250 and a number average molecular weight of 3000 was prepared by a conventional method using benzyl acrylate and methacrylic acid as raw materials. The polymer was neutralized with an aqueous potassium hydroxide solution and diluted with ion-exchanged water, thus preparing a homogeneous 50-mass % polymer solution.

Then, 200 g of the polymer solution, 100 g of C.I. pigment blue 15:3, and 700 g of ion-exchanged water were mixed and mechanically stirred for a predetermined time. The mixture was then subjected to centrifugal separation processing to remove undispersed substances containing coarse particles, thus obtaining a cyan dispersion liquid. The obtained cyan dispersion liquid had a pigment concentration of 10 mass %.

### (C2) Preparation of Ink

An ink was prepared by using the cyan dispersion liquid and adding the following components to it to have a predetermined concentration. After these components were fully mixed and stirred, they were pressure-filtrated through a microfilter of a 2.5-μm pore size (available from Fujifilm), thus preparing a pigment ink having a pigment concentration of 2 mass %.

| | | |
|---|---|---|
| the cyan dispersion liquid | 20 | parts |
| the resin particle dispersion liquid | 40 | parts |
| wax particles | 3 | parts |
| Zonyl FSO-100 (fluorine surfactant | 0.05 | parts |
| available from DuPont) | | |
| 2-methyl-1,3-propanediol | 15 | parts |
| 2-pyrrolidone | 5 | parts |
| acetylene glycol EO adduct (available | 0.5 | parts |
| from Kawaken Fine Chemicals) | | |

| | |
|---|---|
| ion-exchanged water | balance |

### Magenta Ink

### (M1) Preparation of Dispersion Liquid

An AB block polymer having an acid value of 300 and a number average molecular weight of 2500 was prepared by a conventional method using benzyl acrylate and methacrylic acid as raw materials. The polymer was neutralized with an aqueous potassium hydroxide solution and diluted with ion-exchanged water, thus preparing a homogeneous 50-mass % polymer solution.

Then, 100 g of the polymer solution, 100 g of C.I. pigment red 122, and 800 g of ion-exchanged water were mixed and mechanically stirred for a predetermined time. The mixture was then subjected to centrifugal separation processing to remove undispersed substances containing coarse particles, thus obtaining a magenta dispersion liquid. The obtained magenta dispersion liquid had a pigment concentration of 10 mass %.

### (M2) Preparation of Ink

An ink was prepared by using the magenta dispersion liquid and adding the following components to it to have a predetermined concentration. After these components were fully mixed and stirred, they were pressure-filtrated through a microfilter of a 2.5-μm pore size (available from Fujifilm), thus preparing a pigment ink having a pigment concentration of 3 mass %.

| | | |
|---|---|---|
| the magenta dispersion liquid | 30 | parts |
| the resin particle dispersion liquid | 40 | parts |
| wax particles | 3 | parts |
| Zonyl FSO-100 (fluorine surfactant | 0.05 | parts |
| available from DuPont) | | |
| 2-methyl-1,3-propanediol | 15 | parts |
| 2-pyrrolidone | 5 | parts |
| acetylene glycol EO adduct (available | 0.5 | parts |
| from Kawaken Fine Chemicals) | | |

| | |
|---|---|
| ion-exchanged water | balance |

### Yellow Ink

### (Y1) Preparation of Dispersion Liquid

An anionic polymer P-1 was neutralized with an aqueous potassium hydroxide solution and diluted with ion-exchanged water, thus preparing a homogeneous 10-mass % polymer solution.

Then, 300 g of the polymer solution, 100 g of C.I. pigment yellow 74, and 600 g of ion-exchanged water were mixed and mechanically stirred for a predetermined time. The mixture was then subjected to centrifugal separation processing to remove undispersed substances containing coarse particles, thus obtaining a yellow dispersion liquid. The obtained yellow dispersion liquid had a pigment concentration of 10 mass %.

### (Y2) Preparation of Ink

After the following components were mixed, fully stirred, dissolved, and dispersed, they were pressure-filtrated through a microfilter of a 1.0-μm pore size (available from Fujifilm), thus preparing a pigment ink having a pigment concentration of 3 mass %.

| | | |
|---|---|---|
| the yellow dispersion liquid | 30 | parts |
| the resin particle dispersion liquid | 40 | parts |
| wax particles | 3 | parts |
| Zonyl FSO-100 (fluorine surfactant | 0.025 | parts |
| available from DuPont) | | |
| 2-methyl-1,3-propanediol | 15 | parts |
| 2-pyrrolidone | 5 | parts |
| acetylene glycol EO adduct (available | 1 | part |
| from Kawaken Fine Chemicals) | | |

| | |
|---|---|
| ion-exchanged water | balance |

### White Ink

### (W1) Preparation of White Dispersion Liquid

An anionic polymer P-1 [styrene/butyl acrylate/acrylic acid copolymer (polymerization ratio (weight ratio)=30/40/30), acid value of 202, weight-average molecular weight of 6500] was prepared. The polymer was neutralized with an aqueous potassium hydroxide solution and diluted with ion-exchanged water, thus preparing a homogeneous 10-mass % polymer solution.

Then, 150 g of the polymer solution, 500 g of titanium oxide, and 350 g of ion-exchanged water were mixed, and titanium oxide was dispersed using a homogenizer. The mixture was then subjected to centrifugal separation processing to remove undispersed substances containing coarse particles, and a proper amount of ion-exchanged water was added, thus obtaining a white dispersion liquid. The obtained white dispersion liquid had a pigment concentration of 30 mass %.

### (W2) Preparation of White Ink

A white ink was prepared by using the white dispersion liquid and mixing the following components with the white dispersion liquid. After these components were fully stirred, dissolved, and dispersed, they were pressure-filtrated through a microfilter of a 2.5-μm pore size (available from Fujifilm), thus preparing a pigment ink having a pigment concentration of 4 mass %.

| | | |
|---|---|---|
| the white dispersion liquid | 40 | parts |
| the aqueous resin emulsion dispersion liquid | 40 | parts |
| Zonyl FSO-100 (fluorine surfactant | 0.025 | parts |
| available from DuPont) | | |
| 2-methyl-1,3-propanediol | 15 | parts |
| 2-pyrrolidone | 5 | parts |
| acetylene glycol EO adduct (available | 1 | parts |
| from Kawaken Fine Chemicals | | |

| | |
|---|---|
| ion-exchanged water (available | balance |
| from Kawaken Fine Chemicals) | |

### Reactive Liquids

The reactive liquid used in this embodiment contains a plurality of reactants that react with pigment or resin particles contained in ink to coagulate the pigment or resin particles or cause gelatinization. In this embodiment, two different types of reactive liquids, that is, the first reactive liquid RCT1 and the second reactive liquid RCT2 are used.

The reactive liquid contains a reactant that reacts with a color material component contained in ink to coagulate the color material or cause gelatinization of it. Here, the reactant is a component that can reduce the dispersion stability of ink when the reactant is mixed on a print medium or the like with the ink containing a pigment stably dispersed in an aqueous medium due to the action of an ionic group. More specifically, a polyvalent metal salt, a water-soluble cationic polymer with a cationic group, a water-soluble organic acid, or the like can be used as the reactant of the reactive liquid.

RCT1 preferably contains at least a multivalent metal salt as the reactant. RCT1 is a reactive liquid mainly used for color ink. The multivalent metal salt can control a coagulation state when mixed with color ink, and is expected to improve image quality characteristics such as gloss and color development.

RCT2 contains at least a cationic polymer as the reactant. RCT2 is a reactive liquid mainly used for white ink. The cationic polymer contains many ionic polar groups in a single polymer molecule, has high charge density, and thus excels at reducing the dispersibility of a color material pigment.

The reactive liquid containing a large amount of reactant such as the cationic polymer exhibits strong coagulation when mixed with color ink. Ink dots strongly coagulate on a print medium, which hinders leveling (smoothing) of ink dots and degrades the image quality characteristics of a printed product. White ink is used to control the light blocking effect of an image when a transparent film or the like is used as a print medium. In this case, it is necessary to form a white ink layer excellent in shielding (masking) against light coming from the opposite side of a print surface, and the content of the color material is larger than that of color ink. To properly coagulate white ink containing a large amount of color material on a print medium and form a stacked image, RCT2 preferably contains at least the cationic polymer.

Note that the polyvalent metal salt is an example of the “first reactant”, and the cationic polymer is an example of the “second reactant”. In this embodiment, the content of the reactive component is preferably 0.1 mass % or more and 90.0 mass % or less, and more preferably 1.0 mass % or more and 70.0 mass % or less with respect to the total mass of the composition contained in the reactive liquid.

### RCT1

Magnesium sulfate (available from Fujifilm Wako Pure Chemical Corporation) was used as a reactant component, and RCT1 was prepared by mixing the following components.

| | | |
|---|---|---|
| magnesium sulfate | 2 | parts |
| 2-pyrrolidone | 5 | parts |
| 2-methyl-1,3-propanediol | 15 | parts |
| acetylene glycol EO adduct (available | 0.5 | parts |
| from Kawaken Fine Chemicals) | | |

| | |
|---|---|
| ion-exchanged water | balance |

### RCT2

A cationic polymer was used as a reactant component, and RCT2 was prepared by mixing the following components. The cationic polymer was compounded to have the following weight in solid content conversion in consideration of the solid contents of a solution used.

| | | |
|---|---|---|
| cationic polymer (UNISENCE FPA100LU | 2 | parts |
| available from Senka) | | |
| 2-pyrrolidone | 5 | parts |
| 2-methyl-1,3-propanediol | 15 | parts |
| acetylene glycol EO adduct (available | 0.5 | parts |
| from Kawaken Fine Chemicals) | | |

| | |
|---|---|
| ion-exchanged water | balance |

The above-mentioned RCT1 and RCT2 are examples of the “first reactive liquid” and “second reactive liquid”, respectively. In this embodiment, RCT1 contains only a polyvalent metal salt as the reactant, but suffices to contain at least the polyvalent metal salt and may contain a plurality of types of reactants. RCT2 contains only a cationic polymer as the reactant, but suffices to contain at least the cationic polymer and may contain a plurality of types of reactants.

For example, RCT1 may contain only a polyvalent metal salt as the reactant, and RCT2 may contain both a polyvalent metal salt and a cationic polymer. Alternatively, RCT1 may contain both a polyvalent metal salt and a cationic polymer, and RCT2 may contain only a cationic polymer as the reactant. Alternatively, both RCT1 and RCT2 may contain both a polyvalent metal salt and a cationic polymer as the reactant at different content ratios.

### <Details of Reactive Liquid Application Amount Setting (S404)>

A reactive liquid application amount determination method suitable for executing the image printing method according to this embodiment will be described in detail. In this embodiment, the color inks and the white ink are directly applied and printed on the print medium 12. Based on information of the application amount of ink, information about the reactive liquid is determined for each predetermined area of the print medium 12.

First, generation of RCT data in accordance with the total application amount of black, cyan, magenta, and yellow color inks applied to each predetermined area of the print medium 12 will be explained. Note that information of the application amount of ink used for RCT data generation processing need not always be the total application amount of color inks, and RCT data may be generated in accordance with the application amounts of white ink and color inks.

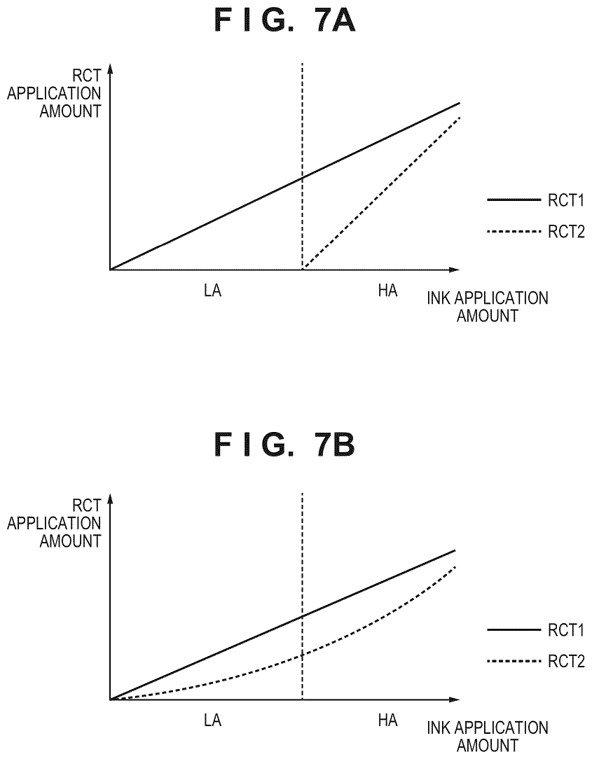

FIGS. 7A and 7B are graphs showing tables in which the relationship between the ink application amount and the reactive liquid application amount is stored. That is, FIGS. 7A and 7B are graphs for explaining the contents of the RCT data LUT described in step S404. FIGS. 7A and 7B exemplify different tables, respectively. FIGS. 7A and 7B show an example of LUTs for a printed product obtained by printing on a vinyl chloride sheet IJ1220-10 (glossy) (3M Japan) by the inkjet printing apparatus according to this embodiment. The image processing unit 300 controls the application amounts of RCT1 and RCT2 in accordance with the application amounts of color inks based on the LUTs corresponding to FIGS. 7A and 7B.

Note that an optimum relationship between the application amounts of color inks and reactive liquids can differ depending on the print medium, the print mode, and the like. The image processing unit 300 prepares in advance in the ROM 302 a plurality of tables corresponding to respective print modes, and the control unit performs processing by looking up a proper LUT in accordance with a set print mode. When generating RCT data for the respective color inks, different tables may be used for the respective color inks. These tables can be determined for respective print conditions in consideration of the graininess of a print image, bleeding, and suppression of precipitation.

In FIG. 7A, the abscissa represents the color ink application amount, and the ordinate represents the RCT application amount. The abscissa is sectioned into a low-tone area (LA) where the color ink application amount is small (low duty), and a high-tone area (HA) where the color ink application amount is large (high duty). A threshold application amount serving as the boundary between the high-tone area and the low-tone area can be arbitrarily set. At the boundary between the areas, the reactive liquid application amount is set in consideration of the continuity of an image so that the graphs of RCT1 and RCT2 become continuous.

Note that the color ink application amount serving as the reference value of the area boundary, which is an index for using different reactive liquid discharge control operations, changes depending on the ink and reactive liquid used, the type of print medium, and the like. The color ink application amount is appropriately selected within the range of 16 to 48 ng/600 dpi corresponding to the range of a print duty of 100% to 300%. Note that a criterion for covering a predetermined area of the print medium 12 is the print duty=100%, and a criterion for saturating the color density of an image is the print duty=300%.

As shown in FIG. 7A, in the low-tone area, only RCT1 is selected, an application amount based on the table is determined, and printing is performed in a predetermined area of the print medium 12. In the high-tone area, both RCT1 and RCT2 are selected, application amounts based on the tables are respectively determined, and printing is performed in a predetermined area of the print medium 12. Further, in the high-tone area, the ratio of the application amount of RCT2 to the total application amount of RCT1 and RCT2 is changed in accordance with the color ink application amount. More specifically, the ratio of the application amount of RCT2 is changed so that the ratio of RCT2 becomes higher for a larger color ink application amount.

Note that for a table in which only RCT2 is selected in the high-tone area and only RCT1 is selected in the low-tone area, the tone of a print image may not be continuous at the boundary between the two tone areas. To prevent this, in FIG. 7A, as the color ink application amount increases, the ratio of application of RCT1 is decreased and that of application of RCT2 is increased.

As described above, only RCT1 is selected to print in the low-tone area. In the low-tone area, the color density is low, so the white turbidity of an image caused by precipitation hardly stands out. However, the low-tone area is not completely covered with ink (print duty is less than 100%), and the print surface readily becomes uneven and poor in gloss owing to coagulation. In the low-tone area, therefore, only RCT1 is selected to print, which can improve the gloss of an image (compared to a case where only RCT2 is selected or a case where both RCT1 and RCT2 are used).

To the contrary, in the high-tone area, the ink application amount is large, and the print image surface tends to be smooth. This prevents a decrease in gloss of a print image caused by strong coagulation of a cationic polymer. However, the color density of the image is high, and the white turbidity of an image caused by precipitation is readily conspicuous. Hence, in this area, both RCT1 and RCT2 are used to print, which can suppress the white turbidity caused by precipitation.

As described above, according to the first embodiment, the component of a reactive liquid is changed in accordance with the print tone of ink (application amount of ink) in the inkjet printing apparatus that uses inks and reactive liquids. This can implement high-quality image printing that satisfies both the gloss in a print area of low print tone and color development in a print area of high print tone.

Note that in an example described in the above embodiment, the table (FIG. 7A) for using RCT1 and RCT2 in only the high-tone area is used. However, generation of precipitation sometimes needs to be suppressed even in the low-tone area depending on the concentration of the contained reactant, the reactivity with color ink, and the type of print medium. In such a case, a LUT as shown in FIG. 7B can be used to suppress precipitation in a lower-tone area. In the LUT of FIG. 7B, RCT1 and RCT2 are used in both the low- and high-tone areas, and the ratio of RCT2 is set to be higher as the application amount of color ink increases.

In this embodiment, control using the total application amount of color inks as information of the ink application amount used in reactive liquid data generation processing has been explained. However, reactive liquid data may be generated based on information of the application amount of each color ink, as described above. More specifically, the influence of degradation of color development caused by white turbidity changes depending on the brightness of an image. Thus, different LUTs are used for inks of different brightnesses of an image even at the same ink application amount. For example, the ratio of the application amount of RCT2 is increased for black K lower in brightness than yellow Y of the same ink application amount. This can provide a more glossy image in the use of an ink with which the influence of degradation of color development caused by white turbidity is small. Similarly, when dark and light inks different in the amount of a color material contained in ink are used, different LUTs may be used for the respective inks.

Although reactive liquid data generation processing for color ink has been explained in this embodiment, similar control may be performed on white ink. For white ink, not only gloss but also the adhesion to a print medium decrease owing to the above-mentioned strong coagulation of a cationic polymer, and an ink film may be readily scratched from the print medium particularly in the low-tone area. Even in this case, control according to this embodiment can be adopted to suppress a decrease in adhesion to a print medium.

When printing is performed on a transparent print medium (for example, a transparent film), an image of high color development can be obtained by stacking a white ink layer printed with white ink and a color ink layer printed with color ink. Even in this case, control according to this embodiment can be adopted to control the gloss and precipitation. For example, there are a method of applying white ink first on a print medium and then applying color ink on the white ink layer, and a method of applying the respective inks in reverse order. Note that the number of layers need not always be two, and printing may be performed by stacking a plurality of color ink layers and a plurality of white ink layers.

Note that an applicable ink is not limited to only the above-described composition. As the color ink, a dye ink, a pigment ink, or both of them can be used. The ink is applicable to various inkjet printing methods such as a so-called full-line type printing method that adopts a long printhead extending in the direction of width of a print medium.

### Second Embodiment

In the second embodiment, the reactive liquid application amount is further controlled in accordance with the temperature (predetermined fixing temperature) of a print medium in a heating/fixing process after printing with ink and a reactive liquid. More specifically, a form in which a different LUT is selected in accordance with the fixing temperature will be explained. Note that the apparatus configuration (FIGS. 1A to 3), the compositions of inks and reactive liquids, and the preparation methods of the inks and reactive liquids are similar to those in the first embodiment, and a description thereof will not be repeated.

### <Operation of Apparatus>

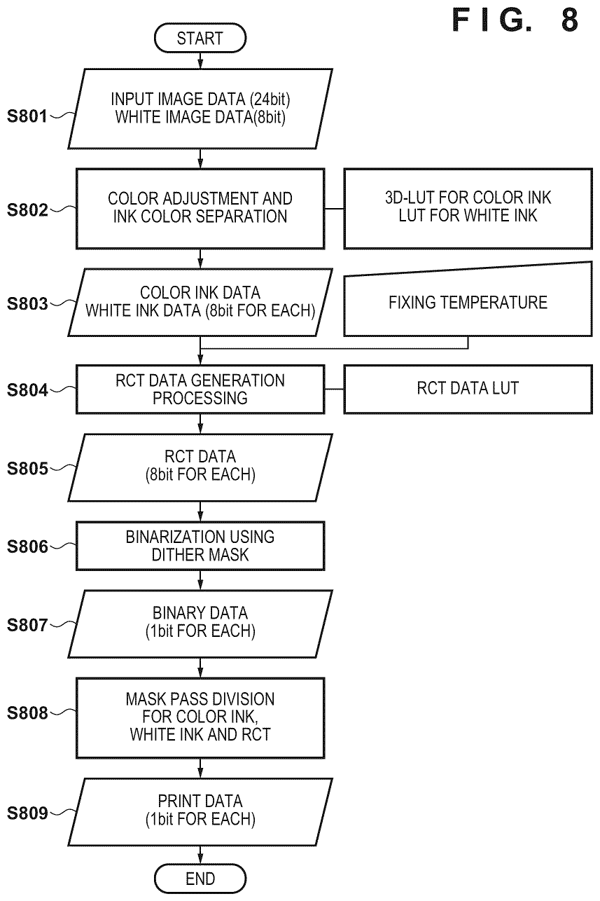

FIG. 8 is a flowchart showing an image data processing sequence according to the second embodiment. Note that steps S801 to S803 and S805 to S809 are similar to steps S401 to S403 and S405 to S409 in the first embodiment, and a description thereof will not be repeated.

In step S804, an image processing unit 300 generates reactive liquid (RCT) data based on the fixing temperature (temperature of a print medium at the time of fixing), color ink data, and white ink data. More specifically, the image processing unit 300 selects a different RCT data LUT in accordance with a fixing temperature set by the user.

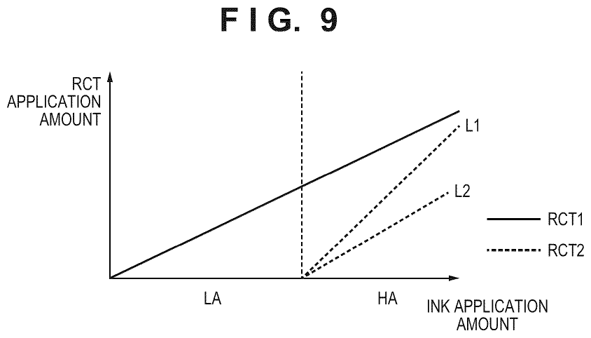

FIG. 9 is a graph showing a table in which the relationship between the ink application amount and the reactive liquid application amount is stored. That is, FIG. 9 is a graph for explaining the contents of the RCT data LUT referred to in step S804. In FIG. 9, L1 represents a LUT for RCT2 selected when the fixing temperature is 80° C. (T1), and L2 represents a LUT for RCT2 selected when the fixing temperature is 90° C. (T2). T1 and T2 are examples of the “first temperature” and the “second temperature”, respectively. In the second embodiment, LUTs as shown in FIG. 9 are stored in a ROM 302 for a plurality of fixing temperatures in regard to a combination of the application amounts of RCT1 and RCT2 at each color ink application amount and each white ink application amount.

Here, L1 exemplifies a LUT similar to FIG. 7A. In L2, RCT printed in each tone area is similar. That is, only RCT1 is selected in the low-tone area, and both RCT1 and RCT2 are used in the high-tone area. In both L1 and L2, the ratio of the application amount of RCT2 to the total application amount of RCT1 and RCT2 changes in accordance with the color ink application amount in the high-tone area. However, a change of the ratio of the application amount of RCT2 to the total application amount of RCT1 and RCT2, which corresponds to a change of the color ink application amount, differs between L1 and L2 (that is, depending on the fixing temperature).

When the reactive liquid application amount is determined using the same LUT, white turbidity is less likely to occur at a higher fixing temperature. This is because as the drying speeds of ink and a reactive liquid are higher, the ink and the reactive liquid more hardly grow into large crystals, and degradation of color development by precipitation rarely occurs. Thus, at the higher temperature T2 (>T1), L2 is used as a LUT for RCT2 to control the application amount of RCT2 to be smaller.

As described above, according to the second embodiment, in addition to the control according to the first embodiment, the application amounts of two types of reactive liquids are changed based on the fixing temperature in the inkjet printing apparatus that uses inks and reactive liquids. This control can implement a more glossy image in the high-tone area, and reduce the ink consumption amount of RCT2.

Note that control of selecting a different LUT in accordance with the fixing temperature has been exemplified in this embodiment, but control of selecting a different LUT in accordance with the type of print medium may be performed. For example, a different table may be selected in accordance with the ink absorption of a print medium, or a different table may be selected in accordance with the temperature and humidity of the use environment of the printing apparatus.

Note that a method of evaluating the ink absorption of a print medium is, for example, the Bristow method described in No. 51 “Liquid Absorbency Test Method for Paper and Board” of the “JAPAN TAPP Paper and Pulp Test Methods”. Explanations of this method are provided in many commercially available books, so a detailed description of this will be omitted, but the outline is as follows.

A predetermined amount of ink is injected into a holding container having an opening slit of a predetermined size. The ink is brought via a slit into contact with a print medium that is processed into a strip and wound around a disk. While the position of the holding container is fixed, the disk is rotated, and the area (length) of the ink band transferred to the print medium is measured. The transfer amount (ml/m²) per unit area can be calculated from the measured ink band area. The transfer amount (ml/m²) represents the volume of ink absorbed by the print medium in a predetermined time. Here, the predetermined time is defined as the transfer time. The transfer time (msec^{1/2}) corresponds to the contact time between the slit and the print medium, and is converted from the disk speed and the width of the opening slit.

Effects similar to those in the above-described embodiment can be obtained by selecting a LUT that reduces the application amount of RCT2 for a print medium of a large transfer amount (=high absorption) in a transfer time of 1 sec.

### Third Embodiment

In the third embodiment, the reactive liquid application amount is further controlled in accordance with the glossiness of a print medium used for printing. More specifically, a form in which a different LUT is selected in accordance with the glossiness will be explained. Note that the apparatus configuration (FIGS. 1A to 3), the compositions of inks and reactive liquids, and the preparation methods of the inks and reactive liquids are similar to those in the first embodiment, and a description thereof will not be repeated.

### <Operation of Apparatus>

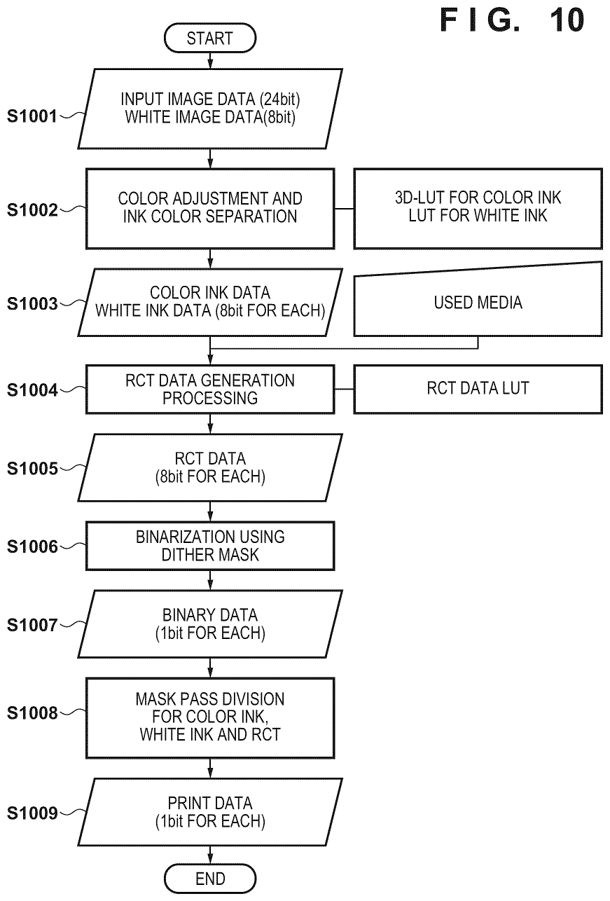

FIG. 10 is a flowchart showing an image data processing sequence according to the third embodiment. Note that steps S1001 to S1003 and S1005 to S1009 are similar to steps S401 to S403 and S405 to S409 in the first embodiment, and a description thereof will not be repeated.

In step S1004, an image processing unit 300 generates reactive liquid (RCT) data based on the glossiness of a print medium, color ink data, and white ink data. More specifically, the image processing unit 300 selects a different RCT data LUT in accordance with the glossiness of a print medium used for printing.

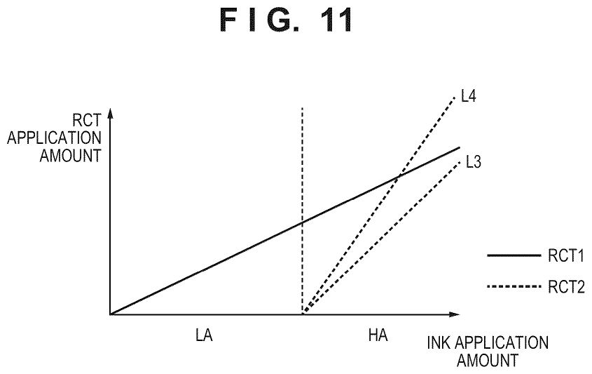

FIG. 11 is a graph showing a table in which the relationship between the ink application amount and the reactive liquid application amount is stored. That is, FIG. 11 is a graph for explaining the contents of the RCT data LUT referred to in step S1004. In FIG. 11, L3 represents a LUT selected when the print medium is a vinyl chloride sheet “IJ1220-10 (glossy)”. L4 represents a LUT selected when the print medium is a vinyl chloride sheet “IJ1220-20 (matte)” (3M Japan). In the following description, these vinyl chloride sheets will be referred to as a “glossy vinyl chloride sheet” and a “matte vinyl chloride sheet”. The glossiness (measured at an angle of) 60° of a matte vinyl chloride sheet JIS Z8741 is lower than that of a glossy vinyl chloride sheet. The glossy vinyl chloride sheet and the matte vinyl chloride sheet are examples of the “first print medium” and the “second print medium”, respectively.

Here, L3 exemplifies a LUT similar to FIG. 7A. In L4, RCT printed in each tone area is similar. That is, only RCT1 is selected in the low-tone area, and both RCT1 and RCT2 are used in the high-tone area. In both L3 and L4, the ratio of the application amount of RCT2 to the total application amount of RCT1 and RCT2 changes in accordance with the color ink application amount in the high-tone area. However, a change of the ratio of the application amount of RCT2 to the total application amount of RCT1 and RCT2, which corresponds to a change of the color ink application amount, differs between L3 and L4 (that is, depending on the glossiness of a print medium).

When the reactive liquid application amount is determined using the same LUT, the influence of a decrease in gloss becomes smaller for a lower glossiness of a print medium. This is because, when the glossiness of a print medium itself is low, the influence hardly differs between printing using a reactive liquid of a strong coagulation force and printing using a reactive liquid of a weak coagulation force. From this, L4 is used for a print medium (matte vinyl chloride sheet) of lower glossiness to control the application amount of RCT2 to be larger in the high-tone area.

In this embodiment, information about the glossiness of a print medium is stored in advance as a table in a ROM 302, and the information is obtained in step S1004. Alternatively, a sensor that measures a glossiness may be provided in the printing apparatus main body to measure the glossiness of a print medium and select a table based on the measured glossiness. In this case, the above-described reactive liquid application amount control can be executed for even a print medium of a type other than those stored in advance in the ROM 302.

As described above, according to the third embodiment, in addition to the control according to the first embodiment, the application amounts of two types of reactive liquids are changed based on the glossiness of a print medium in the inkjet printing apparatus that uses inks and reactive liquids. This control yields an effect of further reducing the influence of white turbidity on an image in the high-tone area of a low-glossiness print medium, compared to the first embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-122548, filed Jul. 29, 2024, which is hereby incorporated by reference herein in its entirety.

What is claimed is:

1. An inkjet printing apparatus comprising:
a printing unit configured to print an image on a print medium, the printing unit including a first discharge portion configured to apply, to the print medium, ink containing resin particles and a color material, and a second discharge portion configured to apply, to the print medium, a reactive liquid that reacts with the resin particles and the color material in the ink to coagulate the resin particles and the color material or cause gelation; and
a determination unit configured to determine an application amount of the reactive liquid based on an application amount of the ink for each partial area of the print medium,
wherein the second discharge portion is configured to apply, as the reactive liquid, at least one of a first reactive liquid having a first composition and a second reactive liquid having a second composition different from the first composition, and
the determination unit determines an application amount of the first reactive liquid and an application amount of the second reactive liquid to make different a first ratio serving as a ratio of the application amount of the second reactive liquid to a total application amount of the first reactive liquid and the second reactive liquid in a case where the application amount of the ink is a first application amount, and a second ratio serving as a ratio of the application amount of the second reactive liquid to the total application amount of the first reactive liquid and the second reactive liquid in a case where the application amount of the ink is a second application amount larger than the first application amount.

2. The apparatus according to claim 1, wherein the first reactive liquid contains a polyvalent metal salt or an organic acid as the first composition, and
the second reactive liquid contains a cationic polymer as the second composition.

3. The apparatus according to claim 2, wherein the determination unit determines the application amount of the first reactive liquid and the application amount of the second reactive liquid to set the second ratio to be higher than the first ratio.

4. The apparatus according to claim 1, wherein the first discharge portion is configured to apply a plurality of color inks of different colors, and
the determination unit determines the application amount of the first reactive liquid and the application amount of the second reactive liquid based on a total application amount of the plurality of color inks.

5. The apparatus according to claim 1, wherein the first discharge portion is configured to apply a plurality of color inks of different colors,
the determination unit determines the application amount of the first reactive liquid and the application amount of the second reactive liquid for an application amount of each of the plurality of color inks, and
at least one of the first ratio and the second ratio is different as for a first color ink and a second color ink included in the plurality of color inks.

6. The apparatus according to claim 2, further comprising a fixing unit configured to fix, to the print medium by heating at a predetermined fixing temperature, an image printed by the printing unit,
wherein the determination unit determines the application amount of the first reactive liquid and the application amount of the second reactive liquid to set, in at least a high-tone area where the application amount of the ink is larger than a threshold application amount, a third ratio serving as a ratio of the application amount of the second reactive liquid to the total application amount of the first reactive liquid and the second reactive liquid in a case where the fixing temperature is a first temperature, to be higher than a fourth ratio serving as a ratio of the application amount of the second reactive liquid to the total application amount of the first reactive liquid and the second reactive liquid in a case where the fixing temperature is a second temperature higher than the first temperature.

7. The apparatus according to claim 2, further comprising an obtaining unit configured to obtain information about absorption of the ink on the print medium,
wherein the determination unit determines the application amount of the first reactive liquid and the application amount of the second reactive liquid to set, in at least a high-tone area where the application amount of the ink is larger than a threshold application amount, a third ratio serving as a ratio of the application amount of the second reactive liquid to the total application amount of the first reactive liquid and the second reactive liquid in a case where the absorption is a first absorption, to be higher than a fourth ratio serving as a ratio of the application amount of the second reactive liquid to the total application amount of the first reactive liquid and the second reactive liquid in a case where the absorption is a second absorption higher than the first absorption.

8. The apparatus according to claim 2, further comprising an obtaining unit configured to obtain information about glossiness on the print medium,
wherein the determination unit determines the application amount of the first reactive liquid and the application amount of the second reactive liquid to set, in at least a high-tone area where the application amount of the ink is larger than a threshold application amount, a third ratio serving as a ratio of the application amount of the second reactive liquid to the total application amount of the first reactive liquid and the second reactive liquid in a case where the glossiness is a first glossiness, to be lower than a fourth ratio serving as a ratio of the application amount of the second reactive liquid to the total application amount of the first reactive liquid and the second reactive liquid in a case where the glossiness is a second glossiness lower than the first glossiness.

9. An information processing method comprising determining an application amount of a reactive liquid that reacts with resin particles and a color material in ink to coagulate the resin particles and the color material or cause gelation in a case where an application amount of the ink containing the resin particles and the color material is a first application amount for each partial area of a print medium,
wherein in the determining, an application amount of a first reactive liquid having a first composition and an application amount of a second reactive liquid having a second composition different from the first composition are determined, and
in the determining, the application amount of the first reactive liquid and the application amount of the second reactive liquid are determined to make different a first ratio serving as a ratio of the application amount of the second reactive liquid to a total application amount of the first reactive liquid and the second reactive liquid, and a second ratio serving as a ratio of the application amount of the second reactive liquid to the total application amount of the first reactive liquid and the second reactive liquid in a case where the application amount of the ink is a second application amount larger than the first application amount.

10. A non-transitory computer-readable recording medium storing a program that, when executed by a computer, causes the computer to perform an information processing method comprising determining an application amount of a reactive liquid that reacts with resin particles and a color material in ink to coagulate the resin particles and the color material or cause gelation in a case where an application amount of the ink containing the resin particles and the color material is a first application amount for each partial area of a print medium,
wherein in the determining, an application amount of a first reactive liquid having a first composition and an application amount of a second reactive liquid having a second composition different from the first composition are determined, and
in the determining, the application amount of the first reactive liquid and the application amount of the second reactive liquid are determined to make different a first ratio serving as a ratio of the application amount of the second reactive liquid to a total application amount of the first reactive liquid and the second reactive liquid, and a second ratio serving as a ratio of the application amount of the second reactive liquid to the total application amount of the first reactive liquid and the second reactive liquid in a case where the application amount of the ink is a second application amount larger than the first application amount.
